(19) United States
(12) Patent Application Publication
(10) Pub. No.: US 2025/0350497 A1
(43) Pub. Date: Nov. 13, 2025

(54) METHOD FOR PROCESSING BASEBOARD MANAGEMENT CONTROLLER PORT AND APPLICATION DEVICE THEREOF

(71) Applicant: SUZHOU METABRAIN INTELLIGENT TECHNOLOGY CO., LTD., Suzhou (CN)

(72) Inventors: Weisong GUO, Suzhou, Jiangsu (CN); Xiang CHEN, Suzhou, Jiangsu (CN)

(21) Appl. No.: 19/276,079

(22) Filed: Jul. 22, 2025

Related U.S. Application Data
(63) Continuation of application No. PCT/CN2024/122305, filed on Sep. 29, 2024.

(30) Foreign Application Priority Data
Dec. 29, 2023 (CN) 202311867391.2

(51) Int. Cl. H04L 12/46; H04L 41/0806; H04L 43/106

(52) U.S. Cl. CPC H04L 12/4679; H04L 41/0806; H04L 43/106

(57) ABSTRACT

A method for processing a baseboard management controller port and an application device thereof are provided by embodiments of the present application. The method for processing the baseboard management controller port includes: in response to a boot instruction, acquiring an initial configuration file; configuring the initial configuration file and executing a default mode; in the default mode, receiving a heartbeat trigger signal from a processor via a management port, wherein the heartbeat trigger signal carries configuration information; and configuring a management compact switching processing unit based on the configuration information. The baseboard management controller may boot normally in a default operating state, receive the configuration information of the processor, and function normally even when processor-side adaptation is not adapted. Furthermore, configuration may be performed on demand based on heartbeat communication, and a timeout mechanism is provided to automatically revert to the default mode upon timeout.

### CROSS-REFERENCE TO RELATED APPLICATION

This application claims the priority of the Chinese Patent application filed on Dec. 29, 2023 before the China National Intellectual Property Administration with the application number of 202311867391.2, and the title of “METHOD FOR PROCESSING BASEBOARD MANAGEMENT CONTROLLER PORT AND APPLICATION DEVICE THEREOF”, which is incorporated herein in its entirety by reference.

### FIELD

The present application relates to the technical field of computer systems and, more particularly, to a method for processing a baseboard management controller port, a baseboard management controller, a processor, a white-box switch, an electronic device, and a non-transitory readable storage medium.

### BACKGROUND

A baseboard management controller (BMC) is a system independent of a central processing unit (CPU), typically configured to manage hardware of a server. A common BMC is also based on an advanced reduced instruction set computer (RISC) machine (ARM) core and runs a Linux-based operating system (OS). With the widespread deployment of white-box switches in data centers, BMCs are increasingly being adopted in switches as well, to manage peripherals such as fans and power supplies.

Unlike the BMC, switch systems often integrate a CPU management port and a BMC management port into a single management port. Internally, a compact switching unit is employed to connect a CPU management port and a BMC management port separately, thereby making both a CPU plane and a BMC plane of a device be managed by using a unified network system. In contrast, in typical server systems, network ports for the CPU plane and the BMC plane usually exist independently. However, the following drawback currently exists:
whether in a white-box switch system or a server system, the OS of the CPU plane may not be a fixed commercial version. It may instead be an OS of a user or a test OS used in production. These OSes may vary in their support for sub-ports and their configuration requirements for management compact switching processing units. Consequently, changing the BMC version may significantly increase the great workload, and changing the BMC version is particularly troublesome for scenarios where a changing CPU-side version is common situation for the white-box switch. The white-box switch belongs to common sense, and is a network switch where manufacturers only provide hardware devices and basic support, allowing customers to run their own network operating systems (NOS) on the white-box switch.

### SUMMARY

In view of the above problem, a method for processing a baseboard management controller port, a baseboard management controller, a processor, a white-box switch, an electronic device, and a non-transitory computer-readable storage medium are provided by embodiments of the present application to solve the above problems or at least solve part of the above problems.

In order to solve the above problems, in a first aspect of the prevent application, a method for processing a baseboard management controller port is provided by embodiments of the present application, which is applied to a baseboard management controller. The baseboard management controller and a processor are both connected to a management compact switching processing unit, and a management port is disposed between the baseboard management controller and the processor. The method includes:
in response to a boot instruction, acquiring an initial configuration file;
configuring the initial configuration file and executing a default mode;
in the default mode, receiving a heartbeat trigger signal of the processor via the management port, wherein the heartbeat trigger signal carries configuration information; and
configuring the management compact switching processing unit based on the configuration information.

In some embodiments of the present application, the management compact switching processing unit has a plurality of virtual local area network ports; the configuration information includes a virtual local area network identifier; and the configuring the management compact switching processing unit based on the configuration information includes:
determining a target virtual local area network port from the plurality of virtual local area network ports based on the virtual local area network identifier; and
activating the target virtual local area network port.

In some embodiments of the present application, the management compact switching processing unit is connected to a physical port; the configuration information includes a target state and executing data corresponding to the target state; and the configuring the management compact switching processing unit based on the configuration information includes:
detecting a port state of the physical port; and
in response to the port state matching the target state, configuring the management compact switching processing unit to process the executing data.

In some embodiments of the present application, the method further includes:
in response to the heartbeat trigger signal being not received within a preset aging time, determining that the processor is in a reboot state; and
in response to the processor being in the reboot state, configuring the initial configuration file.

In some embodiments of the present application, the method further includes:
in response to receiving the heartbeat trigger signal within the preset aging time, feeding back a response signal to the processor and updating the preset aging time.

In a second aspect of the present application, a method for processing a baseboard management controller port is provided by embodiments of the present application, which is applied to a processor. The processor and a baseboard management controller are both connected to a management compact switching processing unit, and the management compact switching processing unit is connected to a physical port; the baseboard management controller is configured to, in response to a boot instruction, acquire an initial configuration file, configure the initial configuration file, and execute a default mode; and the method includes:
receiving input configuration data;
generating configuration information based on the configuration data; and
based on a preset heartbeat timing, transmitting a heartbeat trigger signal to the baseboard management controller via a management port, wherein the heartbeat trigger signal carries the configuration information, and the baseboard management controller is further configured to receive the configuration information and configure the management compact switching processing unit based on the configuration information.

In some embodiments of the present application, the configuration data includes a virtual local area network identifier; and the generating the configuration information based on the configuration data includes:
transforming the virtual local area network identifier to generate the configuration information, wherein the baseboard management controller is configured to determine a target virtual local area network port from a plurality of virtual local area network ports based on the virtual local area network identifier; and activating the target virtual local area network port.

In some embodiments of the present application, the management compact switching processing unit is connected to a physical port, the configuration data includes a target state and executing data corresponding to the target state; and the generating the configuration information based on the configuration data includes:
merging the target state and the executing data corresponding to the target state to generate the configuration information, wherein the baseboard management controller is configured to detect a port state of the physical port; and in response to the port state matching the target state, configuring the management compact switching processing unit to process the executing data.

In some embodiments of the present application, the method further includes:
in response to a response signal fed back by the baseboard management controller for the heartbeat trigger signal being not received within a preset aging time, determining that the baseboard management controller is in a reboot state; and
in response to the baseboard management controller being in the reboot state, transmitting the configuration information to the baseboard management controller.

In some embodiments of the present application, the method further includes:
in response to receiving the response signal within the preset aging time, updating the preset aging time.

In a third aspect of the present application, a method for processing a baseboard management controller port is provided by embodiments of the present application, which is applied to a white-box switch. The white-box switch includes a baseboard management controller and a processor, the baseboard management controller and the processor are both connected to a management compact switching processing unit, and the management compact switching processing unit is connected to a physical port; and the method includes:
in response to a boot instruction, acquiring, by the baseboard management controller, an initial configuration file;
configuring, by the baseboard management controller, the initial configuration file and executing a default mode;
receiving, by the processor, input configuration data;
generating, by the processor, configuration information based on the configuration data;
based on a preset heartbeat timing, transmitting, by the processor, a heartbeat trigger signal to the baseboard management controller via a management port, wherein the heartbeat trigger signal carries the configuration information; and
configuring, by the baseboard management controller in the default mode, the management compact switching processing unit based on the configuration information.

In some embodiments of the present application, the generating, by the processor, the configuration information based on the configuration data includes:
transforming a virtual local area network identifier to generate the configuration information; and
the configuring, by the baseboard management controller in the default mode, the management compact switching processing unit based on the configuration information includes:
determining a target virtual local area network port from a plurality of virtual local area network ports based on the virtual local area network identifier; and activating the target virtual local area network port.

In some embodiments of the present application, the management compact switching processing unit is connected to a physical port, the configuration data includes a target state and executing data corresponding to the target state; the generating, by the processor, the configuration information based on the configuration data includes:
merging the target state and the executing data corresponding to the target state to generate the configuration information; and
the configuring, by the baseboard management controller in the default mode, the management compact switching processing unit based on the configuration information includes:
detecting a port state of the physical port, and in response to the port state matching the target state, configuring the management compact switching processing unit to process the executing data.

In some embodiments of the present application, the method further includes:
in response to a response signal fed back by the baseboard management controller for the heartbeat trigger signal being not received within a preset aging time, determining, by the processor, that the baseboard management controller is in a reboot state;
in response to the baseboard management controller being in the reboot state, transmitting, by the processor, the configuration information to the baseboard management controller; and
in response to receiving the response signal within the preset aging time, updating, by the processor, the preset aging time.

In some embodiments of the present application, the method further includes:
in response to the heartbeat trigger signal being not received within a preset aging time, determining, by the baseboard management controller, that the processor is in a reboot state;
in response to the processor being in the reboot state, configuring, by the baseboard management controller, the initial configuration file; and
in response to receiving the heartbeat trigger signal within the preset aging time, feeding back, by the baseboard management controller, a response signal to the processor and updating the preset aging time.

In a fourth aspect of the present application, a baseboard management controller is provided by embodiments of the present application. The baseboard management controller and a processor are both connected to a management compact switching processing unit, and a management port is disposed between the baseboard management controller and the processor; and the baseboard management controller is configured to implement the following steps:
in response to a boot instruction, acquiring an initial configuration file;
configuring the initial configuration file and executing a default mode;
in the default mode, receiving a heartbeat trigger signal of the processor via the management port, wherein the heartbeat trigger signal carries configuration information; and
configuring the management compact switching processing unit based on the configuration information.

In a fifth aspect of the present application, a processor is provided by embodiments of the present application. The processor and a baseboard management controller are both connected to a management compact switching processing unit, and the management compact switching processing unit is connected to a physical port; the baseboard management controller is configured to, in response to a boot instruction, acquire an initial configuration file, configure the initial configuration file, and execute a default mode; and the processor is configured to implement the following steps:
receiving input configuration data;
generating configuration information based on the configuration data; and
based on a preset heartbeat timing, transmitting a heartbeat trigger signal to the baseboard management controller via a management port, wherein the heartbeat trigger signal carries the configuration information, and the baseboard management controller is further configured to receive the configuration information and configure the management compact switching processing unit based on the configuration information.

In a sixth aspect of the present application, a white-box switch is provided by embodiments of the present application, which includes a baseboard management controller and a processor. The baseboard management controller and the processor are both connected to a management compact switching processing unit, and the management compact switching processing unit is connected to a physical port; and the white-box switch is configured to implement the following steps:
in response to a boot instruction, acquiring, by the baseboard management controller, an initial configuration file;
configuring, by the baseboard management controller, the initial configuration file and executing a default mode;
receiving, by the processor, input configuration data;
generating, by the processor, configuration information based on the configuration data;
based on a preset heartbeat timing, transmitting, by the processor, a heartbeat trigger signal to the baseboard management controller via a management port, wherein the heartbeat trigger signal carries the configuration information; and
configuring, by the baseboard management controller in the default mode, the management compact switching processing unit based on the configuration information.

In a seventh aspect of the present application, an electronic device is further provided by embodiments of the present application, which includes a processor, a memory, and a computer program stored on the memory and capable of running on the processor, wherein the computer program, in response to being executed by the processor, implements the steps of the method for processing the baseboard management controller port described above.

In an eighth aspect of the present application, a non-transitory readable storage medium is further provided by embodiments of the present application, storing a computer program therein, wherein the computer program, in response to being executed by a processor, implements the steps of the method for processing the baseboard management controller port described above.

The embodiments of the present application have the following advantages:
according to the embodiments of the present application, in response to the boot instruction, the initial configuration file is acquired; the initial configuration file is configured; the default mode is executed; in the default mode, the heartbeat trigger signal of the processor is received via the management port, wherein the heartbeat trigger signal carries the configuration information; and the management compact switching processing unit is configured based on the configuration information. The baseboard management controller may boot normally in a default operating state, receive the configuration information of the processor, and function normally even when processor-side adaptation is not adapted. Furthermore, configuration may be performed on demand based on heartbeat communication, and a timeout mechanism is provided to automatically revert to the default mode upon timeout.

### BRIEF DESCRIPTION OF THE DRAWINGS

FIG. 1 is a flowchart of steps of a method for processing a baseboard management controller port according to an embodiment of the present application;

FIG. 2 is a flowchart of steps of another processing method for a baseboard management controller port according to an embodiment of the present application;

FIG. 3 is a flowchart of steps of yet another processing method for a baseboard management controller port according to an embodiment of the present application;

FIG. 4 is a schematic diagram of an example architecture for a method for processing a baseboard management controller port according to the present application;

FIG. 5 is a first flowchart of steps of example heartbeat communication of a method for processing a baseboard management controller port according to the present application;

FIG. 6 is a second flowchart of steps of example heartbeat communication of a method for processing a baseboard management controller port according to the present application;

FIG. 7 is a structural block diagram of an electronic device according to an embodiment of the present application; and

FIG. 8 is a structural block diagram of a storage medium according to an embodiment of the present application.

### DETAILED DESCRIPTION

In order to make objects, characteristics, and advantages of the present application clearer, the present application will further be described in detail below with reference to the drawings and implementations.

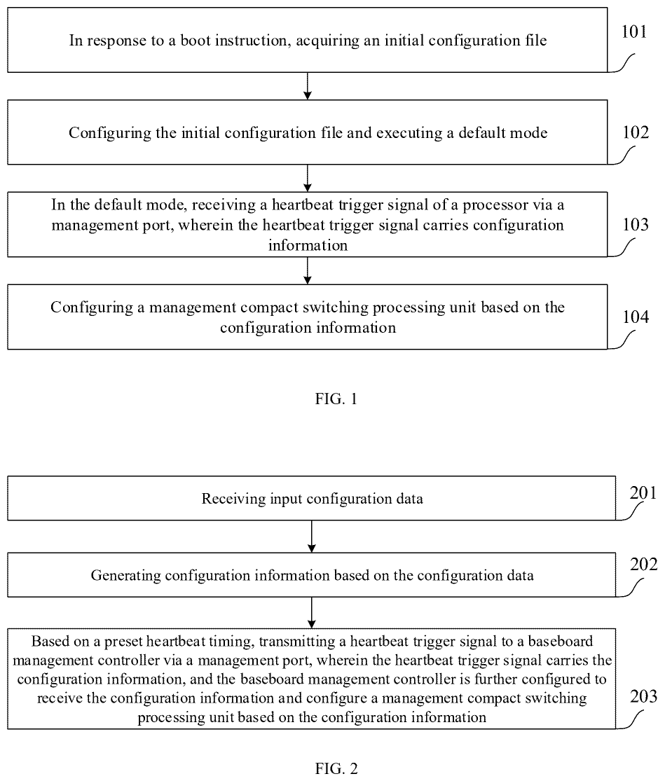

Referring to FIG. 1, which is a flowchart of steps of a method for processing a baseboard management controller port according to an embodiment of the present application. A method for processing a baseboard management controller port is applied to a baseboard management controller (BMC). The baseboard management controller and a processor are both connected to a management compact switching processing unit, and a management port is disposed between the baseboard management controller and the processor. The method for processing the baseboard management controller port includes the following steps:

Step 101, in response to a boot instruction, acquiring an initial configuration file.

During normal boot, the BMC may acquire the initial configuration file from a preset storage space in response to the boot instruction. The processor described above may be a central processing unit (CPU).

Step 102, configuring the initial configuration file and executing a default mode.

The BMC executes the initial configuration file to enable the BMC execute the default mode, so that the BMC may operate in the default mode irrespective of whether the BMC is paired with the CPU.

Step 103, in the default mode, receiving a heartbeat trigger signal of the processor via the management port, wherein the heartbeat trigger signal carries configuration information.

In the default mode, the heartbeat trigger signal sent by the processor is received via the management port. The heartbeat trigger signal carries the configuration information. Each heartbeat trigger signal may carry same configuration information or different configuration information, and this is not limited by the embodiments of the present application.

Step 104, configuring the management compact switching processing unit based on the configuration information.

After receiving the configuration information, the management compact switching processing unit may be configured by using the configuration information, so that the BMC may operate in different port processing modes. The management compact switching processing unit is configured to connect the hardware devices and exchange messages.

In an embodiment of the present application, the management compact switching processing unit has a plurality of virtual local area network ports, the configuration information includes a virtual local area network identifier, and the configuring the management compact switching processing unit based on the configuration information includes: determining a target virtual local area network port from the plurality of virtual local area network ports based on the virtual local area network identifier, and activating the target virtual local area network port.

In the embodiments of the present application, the configuration information may include the virtual local area network identifier, and by using the virtual local area network identifier, a virtual local area network port that matches the virtual local area network identifier among the plurality of virtual local area network ports is determined as the target virtual local area network port. The target virtual local area network port is activated to perform information processing.

In an embodiment of the present application, the management compact switching processing unit is connected to a physical port; the configuration information includes a target state and executing data corresponding to the target state; and the configuring the management compact switching processing unit based on the configuration information includes: detecting a port state of the physical port; and in response to the port state matching the target state, configuring the management compact switching processing unit to process the executing data. The physical port is an external physical port, and is configured to manage the white-box switch, allowing the equipment administrator to access the white-box switch through the network.

In the embodiments of the present application, the management compact switching processing unit is connected to the physical port; the configuration data includes the target state and the executing data corresponding to the target state. The BMC detects a port state of the physical port and determines whether the port state of the physical port matches the target state in the configuration information. In response to the port state matching the target state, the executing data corresponding to the target state may be processed to perform corresponding operations on the port.

In some embodiments of the present application, the method further includes: in response to the heartbeat trigger signal being not received within a preset aging time, determining that the processor is in a reboot state; and in response to the processor being in the reboot state, configuring the initial configuration file.

During the operation of the BMC, a preset aging time exists. As a heartbeat communication mechanism exists between the BMC and the CPU, in response to the heartbeat trigger signal being not received within the preset aging time, it may be determined that the CPU is in the reboot state. In response to the processor being in the reboot state, the initial configuration file may be configured to revert to the default mode.

In some embodiments of the present application, the method further includes: in response to the heartbeat trigger signal being received within the preset aging time, feeding back a response signal to the processor and updating the preset aging time.

In response to the heartbeat trigger signal being received within the preset aging time, that is, the CPU is online, the response signal may be fed back to the CPU and the preset aging time is updated. The detection of the next heartbeat cycle begins.

Referring to FIG. 2, which is a flowchart of steps of another processing method for a baseboard management controller port according to an embodiment of the present application. A method for processing a baseboard management controller port is applied to a processor. The processor and a baseboard management controller are both connected to a management compact switching processing unit, the management compact switching processing unit is connected to a physical port, and the baseboard management controller is configured to, in response to a boot instruction, acquire an initial configuration file, configure the initial configuration file, and execute a default mode; and the method for processing the baseboard management controller port includes:

Step 201, receiving input configuration data.

The processor described above may be a central processing unit (CPU). The CPU may receive configuration data input by a user or other devices.

Step 202, generating configuration information based on the configuration data.

The configuration data is transformed into a message format for interaction with the BMC to generate the configuration information.

Step 203, based on a preset heartbeat timing, transmitting a heartbeat trigger signal to the baseboard management controller via a management port, wherein the heartbeat trigger signal carries the configuration information, and the baseboard management controller is further configured to receive the configuration information and configure the management compact switching processing unit based on the configuration information.

Within a preset heartbeat timing, a heartbeat trigger signal is periodically transmitted to the BMC via the management port, wherein the heartbeat trigger signal carrying the configuration information is transmitted to the BMC. After receiving the configuration information, the BMC configures the management compact switching processing unit based on the configuration information.

In some embodiments of the present application, the configuration data includes a virtual local area network identifier, the generating the configuration information based on the configuration data includes: transforming the virtual local area network identifier to generate the configuration information, wherein the baseboard management controller is configured to determine a target virtual local area network port from a plurality of virtual local area network ports based on the virtual local area network identifier; and activating the target virtual local area network port.

In the embodiments of the present application, the input configuration data may include the virtual local area network identifier. The virtual local area network identifier is transformed to generate the configuration information in the message format. The BMC determines the target virtual local area network port from the plurality of virtual local area network ports based on the virtual local area network identifier; and activates the target virtual local area network port.

In some embodiments of the present application, the management compact switching processing unit is connected to the physical port; the configuration data includes a target state and executing data corresponding to the target state; and the generating the configuration information based on the configuration data includes: merging the target state and the executing data corresponding to the target state to generate the configuration information, wherein the baseboard management controller is configured to detect a port state of the physical port; and in response to the port state matching the target state, configuring the management compact switching processing unit to process the executing data.

In the embodiments of the present application, the configuration data includes the target state and the executing data corresponding to the target state. The target state and the executing data corresponding to the target state may be merged according to a type of the target state to generate the configuration information. The baseboard management controller may be configured to detect a port state of the physical port, and in response to the port state matching the target state, configure the management compact switching processing unit to process the executing data.

In some embodiments of the present application, the method further includes: in response to a response signal fed back by the baseboard management controller for the heartbeat trigger signal being not received within a preset aging time, determining that the baseboard management controller is in a reboot state; and in response to the baseboard management controller is in the reboot state, transmitting the configuration information to the baseboard management controller.

In the embodiments of the present application, during the operation of the CPU, a preset aging time exists. As a heartbeat communication mechanism exists between the BMC and the CPU, in response to the response signal fed back by the BMC for the heartbeat trigger signal being not received within the preset aging time, it may be determined that the BMC is in the reboot state. In response to the BMC being in the reboot state, the initial configuration information may be transmitted to the BMC. The BMC may configure the initial configuration file and boot in a default mode.

In some embodiments of the present application, the method further includes: in response to receiving the response signal within the preset aging time, updating the preset aging time.

In response to the response signal fed back by the BMC being received, it may be determined that the BMC is online, the preset aging time is updated and the next heartbeat cycle begins.

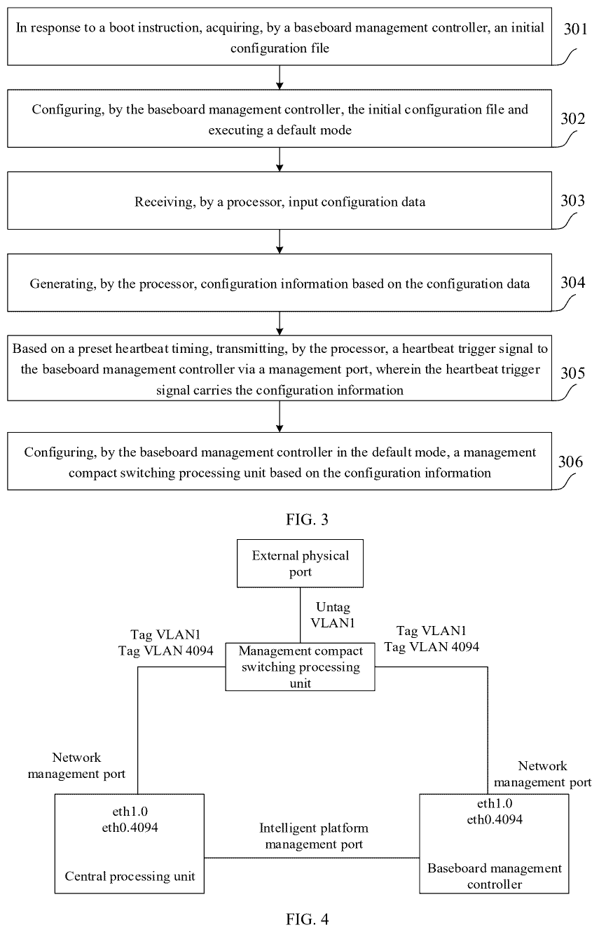

Referring to FIG. 3, which is a flowchart of steps of yet another processing method for a baseboard management controller port according to an embodiment of the present application. The method for processing the baseboard management controller port is applied to a white-box switch. The white-box switch includes a baseboard management controller and a processor, the baseboard management controller and the processor are both connected to a management compact switching processing unit, and the management compact switching processing unit is connected to a physical port; and the method includes:
Step 301, in response to a boot instruction, acquiring, by the baseboard management controller, an initial configuration file;
Step 302, configuring, by the baseboard management controller, the initial configuration file and executing a default mode;
Step 303, receiving, by the processor, input configuration data;
Step 304, generating, by the processor, configuration information based on the configuration data;
Step 305, based on a preset heartbeat timing, transmitting, by the processor, a heartbeat trigger signal to the baseboard management controller via a management port, wherein the heartbeat trigger signal carries the configuration information; and
Step 306, configuring, by the baseboard management controller in the default mode, the management compact switching processing unit based on the configuration information.

In some embodiments of the present application, the generating, by the processor, the configuration information based on the configuration data includes:
transforming a virtual local area network identifier to generate the configuration information, and
the configuring, by the baseboard management controller in the default mode, the management compact switching processing unit based on the configuration information includes:
determining a target virtual local area network port from a plurality of virtual local area network ports based on the virtual local area network identifier; and activating the target virtual local area network port.

In some embodiments of the present application, the management compact switching processing unit is connected to the physical port; the configuration data includes a target state and executing data corresponding to the target state; the generating, by the processor, the configuration information based on the configuration data includes:
merging the target state and the executing data corresponding to the target state to generate the configuration information; and
the configuring, by the baseboard management controller in the default mode, the management compact switching processing unit based on the configuration information includes:
detecting a port state of the physical port, and in response to the port state matching the target state, configuring the management compact switching processing unit to process the executing data.

In some embodiments of the present application, the method further includes:
in response to a response signal fed back by the baseboard management controller for the heartbeat trigger signal being not received within a preset aging time, determining, by the processor, that the baseboard management controller is in a reboot state;
in response to the baseboard management controller being in the reboot state, transmitting, by the processor, the configuration information to the baseboard management controller; and
in response to receiving the response signal within the preset aging time, updating, by the processor, the preset aging time.

In an embodiment of the present application, the method further includes:
in response to the heartbeat trigger signal being not received within a preset aging time, determining, by the baseboard management controller, that the processor is in a reboot state;
in response to the processor being in the reboot state, configuring, by the baseboard management controller, the initial configuration file; and
in response to receiving the heartbeat trigger signal within the preset aging time, feeding back, by the baseboard management controller, a response signal to the processor and updating the preset aging time.

An implementation process may refer to the above embodiments, and this is not repeated herein.

An example is taken for illustration.

Referring to FIG. 4, which shows a connection relationship between a CPU and a BMC. The connection relationship is designed to meet the following requirements: 1. It is ensured that the BMC complies with common industry usage patterns by default, namely, that a restful (idle) communication mode is disabled. When a physical port goes down, management ports of both the CPU and the BMC are shut down accordingly. 2. A management compact switching processing unit may be configured with respect to the following: which state is the management compact switching processing unit set to; whether the management compact switching processing unit possesses a dedicated restful VLAN (REST VLAN channel); which VLAN is designated as the REST VLAN and which is used as the VLAN (common VLAN channel) for management purposes; whether the CPU is notified when the physical port is up or down; and whether an up/down state of the management ports the CPU and the BMC is selected by the CPU. 3. Even in scenarios where the CPU-side operating system (OS) is replaced or the BMC reboots, the system may still boot into a state desired by the OS.

To meet the above-mentioned requirements, the following technical solutions are proposed:

1. During BMC-side boot, a default mode is set. For example, no VLAN is configured on the management compact switching processing unit, and when the physical port goes up or down, the management ports of the CPU and the BMC are directly set to up or down accordingly.

2. The BMC provides an intelligent platform management port (IPMI) management port. The CPU may call the IPMI management port to set the VLAN of the compact switching processing unit, so that an OS on the CPU side may independently set a desired state of the compact switching processing unit, thus the object that users with customization requirements may independently set the expected sub-ports is achieved. For example, the REST VLAN may be set to VLAN 4094, the ports of the switching processing unit connected to the CPU and the BMC will join VLAN 4094 (which is a name of a channel) in a tag mode. The common management sub-port may use VLAN 1 (which is a name of a channel), in which case the VLAN of an external network port is set to be untag VLAN 1, and the VLAN connected to the CPU port is configured as tag VLAN 1, that is, the common VLAN is set to VLAN 1.

3. The BMC provides an IPMI management port and/or a restful management port. When detecting that a physical port is shut down, the BMC may be configured to either immediately disconnect a network management port link between the BMC and the CPU, or merely record a log.

4. The BMC side supports configuring, via the restful port, which syslog (system log) may be transmitted to the CPU side. The BMC ensures that such information is synchronized to the CPU side in a format specified by the CPU.

5. By adding a plugin to the CPU-side syslog, when the log file of the CPU receives the above-mentioned log messages, the plugin records the log messages into a local state database. The CPU side then determines, based on changes in the local state database, whether to bring down the entire network management port or only the corresponding sub-port.

6. An IPMI heartbeat communication mechanism is established between the BMC and the CPU. A heartbeat timeout is used to identify whether the peer has rebooted. The heartbeat signal (also known as a heartbeat message) is initiated by the CPU, and upon receiving the heartbeat signal, the BMC side makes a response. In response to detecting a peer (i.e. the CPU) reboot, the BMC resets the previously states (including any state settings configured by the CPU on the BMC, which may be added in future expansions) to be a default state. This ensures that the BMC operates in a default state after every CPU reboot. In response to detecting a peer (i.e., the BMC) reboot, the CPU side sends a state expected by the CPU side to the BMC, and then the BMC set its state based on the state expected by the CPU side. Another method for maintaining the heartbeat includes: the CPU side periodically reissues relevant settings, and if the settings received by the BMC are identical to current settings, the BMC makes no response, but merely updates its own aging time; and in this way, the processing for the CPU on the aging of the BMC side is omitted.

7. The default aging time at the BMC side is 10 seconds and may be set by the CPU side to a desired value (typically three times a heartbeat interval). The aging time at the CPU side is designated by a CPU-side application program. After receiving the settings or heartbeat message from the CPU side, the BMC side starts or resumes timing.

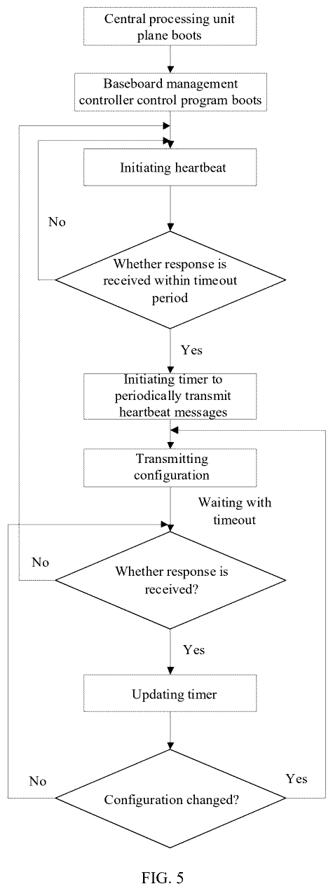

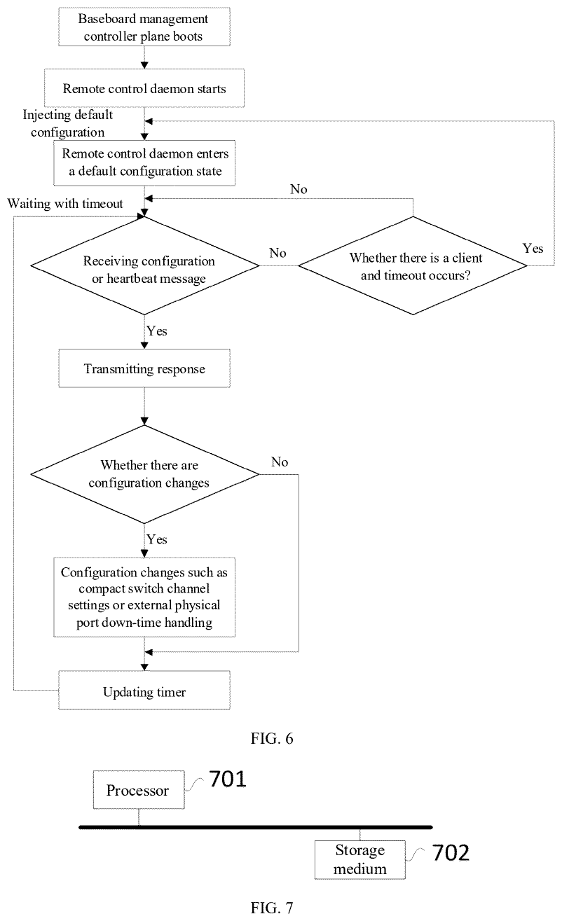

### Referring to FIG. 5 and FIG. 6.

For example, after boot, the CPU side periodically (e.g., every 3 seconds) configures the REST VLAN as VLAN 4094. That is, the ports of the compact switching processing unit connected to the CPU port and the BMC port are both added to VLAN 4094 in a tag mode. The IP address used is 240.127.1.2/30, i.e., the IP address of a sub-port (e.g., eth0.4094) of VLAN 4094 of the network management port (for example, eth0) on the BMC is 240.127.1.2 with a subnet mask of 255.255.255.252. The common VLAN is set to VLAN 1, where the external physical port of the compact switching processing unit is added to VLAN 1 in an untag mode, and both the CPU port and the BMC port are added to VLAN 1 in a tag mode. The BMC is configured to record the log when the external physical port goes down, without shutting down the network management port of the CPU and the network management port of the BMC. The aging time at the BMC side is set to 9 seconds, which is three times a periodic transmission interval. Upon receiving a configuration command (that is, the command that the BMC needs to set its state based on the state expected by the CPU side), the BMC side starts timing. If a set action conflicts with the current state, the BMC side executes the configuration command and updates the timer. If the set action matches the current state, only the timer is updated. If no command is received within the 9 seconds, the BMC revert all related settings to default values.

If the CPU employs an independent heartbeat method, the CPU performs a one-time configuration on the above-mentioned attributes after booting (after receiving the first heartbeat response). Subsequently, the CPU periodically transmits heartbeat messages. The BMC makes response to each received heartbeat message. If the BMC side fails to receive any heartbeat message in 9 seconds, the BMC side will revert all related settings to their default values. At the CPU side, if three consecutive responses are not received, the CPU side determines that the BMC has rebooted. Upon receiving the heartbeat response again, the CPU side reconfigures the above attributes.

It should be noted that, for simple description, each method embodiment is expressed into a combination of a series of actions. However, a person skilled in the art should know that the embodiments of the present application are not limited by an action sequence described herein because some steps may be executed in another sequence or at the same time according to the embodiments of the present application. Second, a person skilled in the art should also know that the embodiments described in the specification all belong to embodiments and involved actions are not always necessary to the embodiments of the present application.

A baseboard management controller is further provided by embodiments of the present application. The baseboard management controller and a processor are both connected to a management compact switching processing unit, and a management port is disposed between the baseboard management controller and the processor; and the baseboard management controller is configured to implement the following steps:
in response to a boot instruction, acquiring an initial configuration file;
configuring the initial configuration file and executing a default mode;
in the default mode, receiving a heartbeat trigger signal of the processor via the management port, wherein the heartbeat trigger signal carries configuration information; and
configuring the management compact switching processing unit based on the configuration information.

In some embodiments of the present application, the management compact switching processing unit has a plurality of virtual local area network ports, the configuration information includes a virtual local area network identifier, and the configuring the management compact switching processing unit based on the configuration information includes:
determining a target virtual local area network port from the plurality of virtual local area network ports based on the virtual local area network identifier; and
activating the target virtual local area network port.

In some embodiments of the present application, the management compact switching processing unit is connected to a physical port; the configuration information includes a target state and executing data corresponding to the target state; and the configuring the management compact switching processing unit based on the configuration information includes:
detecting a port state of the physical port; and
in response to the port state matching the target state, configuring the management compact switching processing unit to process the executing data.

In some embodiments of the present application, the method further includes:
in response to the heartbeat trigger signal is not received within a preset aging time, determining that the processor is in a reboot state; and
in response to the processor is in the reboot state, configuring the initial configuration file.

In some embodiments of the present application, the method further includes:
in response to the heartbeat trigger signal being received within the preset aging time, feeding back a response signal to the processor and updating the preset aging time.

A processor is further provided by embodiments of the present application. The processor and a baseboard management controller are both connected to a management compact switching processing unit, and the management compact switching processing unit is connected to a physical port; the baseboard management controller is configured to, in response to a boot instruction, acquire an initial configuration file, configure the initial configuration file, and execute a default mode; and the processor is configured to perform the following steps:
receiving input configuration data;
generating configuration information based on the configuration data; and
based on a preset heartbeat timing, transmitting a heartbeat trigger signal to the baseboard management controller via a management port, wherein the heartbeat trigger signal carries the configuration information, and the baseboard management controller is further configured to receive the configuration information and configure the management compact switching processing unit based on the configuration information.

In some embodiments of the present application, the configuration data includes a virtual local area network identifier; and the generating the configuration information based on the configuration data includes:
transforming the virtual local area network identifier to generate the configuration information, wherein the baseboard management controller is configured to determine a target virtual local area network port from a plurality of virtual local area network ports based on the virtual local area network identifier; and activating the target virtual local area network port.

In some embodiments of the present application, the management compact switching processing unit is connected to a physical port; the configuration data includes a target state and executing data corresponding to the target state; and the generating the configuration information based on the configuration data includes:
merging the target state and the executing data corresponding to the target state to generate the configuration information, wherein the baseboard management controller is configured to detect a port state of the physical port; and in response to the port state matching the target state, configuring the management compact switching processing unit to process the executing data.

In some embodiments of the present application, the method further includes:
in response to a response signal fed back by the baseboard management controller for the heartbeat trigger signal is not received within a preset aging time, determining that the processor is in a reboot state; and
in response to the processor being in a reboot state, transmitting the configuration information to the baseboard management controller.

In some embodiments of the present application, the method further includes:
in response to receiving the response signal within the preset aging time, updating the preset aging time.

A white-box switch is further provided by embodiments of the present application, which includes a baseboard management controller and a processor. The baseboard management controller and the processor are both connected to a management compact switching processing unit, and the management compact switching processing unit is connected to a physical port; and the white-box switch is configured to implement the following steps:
in response to a boot instruction, acquiring, by the baseboard management controller, an initial configuration file;
configuring, by the baseboard management controller, the initial configuration file and executing a default mode;
receiving, by the processor, input configuration data;
generating, by the processor, configuration information based on the configuration data;
based on a preset heartbeat timing, transmitting, by the processor, a heartbeat trigger signal to the baseboard management controller via a management port, wherein the heartbeat trigger signal carries the configuration information; and
configuring, by the baseboard management controller in the default mode, the management compact switching processing unit based on the configuration information.

In some embodiments of the present application, the generating, by the processor, the configuration information based on the configuration data includes:
transforming a virtual local area network identifier to generate the configuration information; and
the configuring, by the baseboard management controller in the default mode, the management compact switching processing unit based on the configuration information includes:
determining a target virtual local area network port from a plurality of virtual local area network ports based on the virtual local area network identifier; and activating the target virtual local area network port.

In some embodiments of the present application, the management compact switching processing unit is connected to the physical port; the configuration data includes a target state and executing data corresponding to the target state; and the generating, by the processor, the configuration information based on the configuration data includes:
merging the target state and the executing data corresponding to the target state to generate the configuration information;
the configuring, by the baseboard management controller in the default mode, the management compact switching processing unit based on the configuration information includes:
detecting a port state of the physical port, and in response to the port state matching the target state, configuring the management compact switching processing unit to process the executing data.

In some embodiments of the present application, the method further includes:
in response to a response signal fed back by the baseboard management controller for the heartbeat trigger signal being not received within a preset aging time, determining, by the processor, that the baseboard management controller is in a reboot state;
in response to the baseboard management controller being in the reboot state, transmitting, by the processor, the configuration information to the baseboard management controller; and
in response to receiving the response signal within a preset aging time, updating, by the processor, the preset aging time.

In some embodiments of the present application, the method further includes:
in response to the heartbeat trigger signal being not received within a preset aging time, determining, by the baseboard management controller, that the processor is in a reboot state;
in response to the processor being in the reboot state, configuring, by the baseboard management controller, the initial configuration file; and
in response to receiving the heartbeat trigger signal within a preset aging time, feeding back, by the BMC, a response signal to the processor and updating the preset aging time.

As the apparatus embodiments is substantially similar to the method embodiments, a simplified description is provided herein. Reference may be made to the relevant description of the method embodiments.

Referring to FIG. 7, an electronic device is further provided by embodiments of the present application, which includes:

a processor 701 and a storage medium 702, wherein the storage medium 702 stores a computer program executable by the processor 701. When the electronic device operates, the processor 701 executes the computer program to implement the method for processing the baseboard management controller port according to any one of the embodiments of the present application.

First, the method for processing the baseboard management controller port is applied to the baseboard management controller. The baseboard management controller and a processor are both connected to a management compact switching processing unit, and a management port is disposed between the baseboard management controller and the processor. The method includes:
in response to a boot instruction, acquiring an initial configuration file;
configuring the initial configuration file and executing a default mode;
in the default mode, receiving a heartbeat trigger signal of the processor via the management port, wherein the heartbeat trigger signal carries configuration information; and
configuring the management compact switching processing unit based on the configuration information.

In some embodiments of the present application, the management compact switching processing unit has a plurality of virtual local area network ports, the configuration information includes a virtual local area network identifier, and the configuring the management compact switching processing unit based on the configuration information includes:
determining a target virtual local area network port from the plurality of virtual local area network ports based on the virtual local area network identifier; and
activating the target virtual local area network port.

In some embodiments of the present application, the management compact switching processing unit is connected to a physical port; the configuration information includes a target state and executing data corresponding to the target state; and the configuring the management compact switching processing unit based on the configuration information includes:
detecting a port state of the physical port; and
in response to the port state matching the target state, configuring the management compact switching processing unit to process the executing data.

In some embodiments of the present application, the method further includes:
in response to the heartbeat trigger signal being not received within a preset aging time, determining that the processor is in a reboot state; and
in response to the processor is in the reboot state, configuring the initial configuration file.

In some embodiments of the present application, the method further includes:
in response to the heartbeat trigger signal being received within the preset aging time, feeding back a response signal to the processor and updating the preset aging time.

Second, the method for processing the baseboard management controller port is applied to the processor. The processor and a baseboard management controller are both connected to a management compact switching processing unit, the management compact switching processing unit is connected to a physical port; the baseboard management controller is configured to, in response to a boot instruction, acquire an initial configuration file, configure the initial configuration file, and execute a default mode; and the method includes:
receiving input configuration data;
generating configuration information based on the configuration data; and
based on a preset heartbeat timing, transmitting a heartbeat trigger signal to the baseboard management controller via a management port, wherein the heartbeat trigger signal carries the configuration information, and the baseboard management controller is further configured to receive the configuration information and configure the management compact switching processing unit based on the configuration information.

In some embodiments of the present application, the configuration data includes a virtual local area network identifier; and the generating the configuration information based on the configuration data includes:
transforming the virtual local area network identifier to generate the configuration information, wherein the baseboard management controller is configured to determine a target virtual local area network port from a plurality of virtual local area network ports based on the virtual local area network identifier; and activating the target virtual local area network port.

In some embodiments of the present application, the management compact switching processing unit is connected to the physical port; the configuration data includes a target state and executing data corresponding to the target state; and the generating the configuration information based on the configuration data includes:
merging the target state and the executing data corresponding to the target state to generate the configuration information, wherein the baseboard management controller is configured to detect a port state of the physical port; and in response to the port state matching the target state, configuring the management compact switching processing unit to process the executing data.

In some embodiments of the present application, the method further includes:
in response to a response signal fed back by the baseboard management controller for the heartbeat trigger signal being not received within a preset aging time, determining that the baseboard management controller is in a reboot state; and
in response to the baseboard management controller being in the reboot state, transmitting the configuration information to the baseboard management controller.

In some embodiments of the present application, the method further includes:
in response to receiving the response signal within the preset aging time, updating the preset aging time.

Third, the method for processing the baseboard management controller port is applied to the white-box switch. The white-box switch includes a baseboard management controller and a processor, the baseboard management controller and the processor are both connected to a management compact switching processing unit, and the management compact switching processing unit is connected to a physical port; and the method includes:
in response to a boot instruction, acquiring, by the baseboard management controller, an initial configuration file;
configuring, by the baseboard management controller, the initial configuration file and executing a default mode;
receiving, by the processor, input configuration data;
generating, by the processor, configuration information based on the configuration data;
based on a preset heartbeat timing, transmitting, by the processor, a heartbeat trigger signal to the baseboard management controller via a management port, wherein the heartbeat trigger signal carries the configuration information; and
configuring, by the baseboard management controller in the default mode, the management compact switching processing unit based on the configuration information.

In some embodiments of the present application, the generating, by the processor, the configuration information based on the configuration data includes:
transforming a virtual local area network identifier to generate the configuration information; and
the configuring, by the baseboard management controller in the default mode, the management compact switching processing unit based on the configuration information includes:

determining a target virtual local area network port from a plurality of virtual local area network ports based on the virtual local area network identifier; and activating the target virtual local area network port.

In some embodiments of the present application, the management compact switching processing unit is connected to the physical port; the configuration data includes a target state and executing data corresponding to the target state; the generating, by the processor, the configuration information based on the configuration data includes:
merging the target state and the executing data corresponding to the target state to generate the configuration information; and
the configuring, by the baseboard management controller in the default mode, the management compact switching processing unit based on the configuration information includes:
detecting a port state of the physical port, and in response to the port state matching the target state, configuring the management compact switching processing unit to process the executing data.

In some embodiments of the present application, the method further includes:
in response to a response signal fed back by the baseboard management controller for the heartbeat trigger signal being not received within a preset aging time, determining, by the processor, that the baseboard management controller is in a reboot state;
in response to the baseboard management controller being in the reboot state, transmitting, by the processor, the configuration information to the baseboard management controller; and
in response to receiving the response signal within the preset aging time, updating, by the processor, the preset aging time.

In some embodiments of the present application, the method further includes:
in response to the heartbeat trigger signal being not received within the preset aging time, determining, by the baseboard management controller, that the processor is in the reboot state;
in response to the processor being in the reboot state, configuring, by the baseboard management controller, the initial configuration file; and
in response to receiving the heartbeat trigger signal within the preset aging time, feeding back, by the baseboard management controller, a response signal to the processor and updating the preset aging time.

The memory may include a random access memory (RAM), and may also include a non-transitory memory, such as at least one disk storage device. In some embodiments of the present application, the memory may further include at least one storage device located remotely from the above-mentioned processor.

The above-mentioned processor may be a general-purpose processor, including a central processing unit (CPU), a network processor (NP), etc., may also be a digital signal processor (DSP), an application specific integrated circuit (ASIC), a field-programmable gate array (FPGA), or other programmable logic device, discrete gate or transistor logic device, or discrete hardware component.

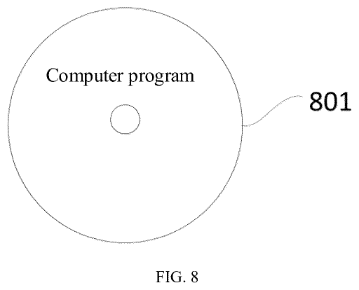

Referring to FIG. 8, a non-transitory readable storage medium 801 is further provided by embodiments of the present application. The non-transitory readable storage medium 801 stores a computer program. The computer program, in response to being executed by a processor, performs the method for processing the baseboard management controller port according to any one of the embodiments of the present application.

First, the method for processing the baseboard management controller port is applied to the baseboard management controller. The baseboard management controller and a processor are both connected to a management compact switching processing unit, and a management port is disposed between the baseboard management controller and the processor. The method includes:
in response to a boot instruction, acquiring an initial configuration file;
configuring the initial configuration file and executing a default mode;
in the default mode, receiving a heartbeat trigger signal of the processor via the management port, wherein the heartbeat trigger signal carries configuration information; and
configuring the management compact switching processing unit based on the configuration information.

In some embodiments of the present application, the management compact switching processing unit has a plurality of virtual local area network ports, the configuration information includes a virtual local area network identifier, and the configuring the management compact switching processing unit based on the configuration information includes:
determining a target virtual local area network port from the plurality of virtual local area network ports based on the virtual local area network identifier; and
activating the target virtual local area network port.

In some embodiments of the present application, the management compact switching processing unit is connected to a physical port; the configuration information includes a target state and executing data corresponding to the target state; and the configuring the management compact switching processing unit based on the configuration information includes: detecting a port state of the physical port; and
in response to the port state matching the target state, configuring the management compact switching processing unit to process the executing data.

In some embodiments of the present application, the method further includes:
in response to the heartbeat trigger signal being not received within a preset aging time, determining that the processor is in a reboot state; and
in response to the processor is in the reboot state, configuring the initial configuration file.

In some embodiments of the present application, the method further includes:
in response to the heartbeat trigger signal being received within the preset aging time, feeding back a response signal to the processor and updating the preset aging time.

Second, the method for processing the baseboard management controller port is applied to the processor. The processor and a baseboard management controller are both connected to a management compact switching processing unit, the management compact switching processing unit is connected to a physical port; the baseboard management controller is configured to, in response to a boot instruction, acquire an initial configuration file, configure the initial configuration file, and execute a default mode; and the method includes:
receiving input configuration data;
generating configuration information based on the configuration data; and
based on a preset heartbeat timing, transmitting a heartbeat trigger signal to the baseboard management controller via a management port, wherein the heartbeat trigger signal carries the configuration information, and the baseboard management controller is further configured to receive the configuration information and configure the management compact switching processing unit based on the configuration information.

In some embodiments of the present application, the configuration data includes a virtual local area network identifier; and the generating the configuration information based on the configuration data includes:

transforming the virtual local area network identifier to generate the configuration information, wherein the baseboard management controller is configured to determine a target virtual local area network port from a plurality of virtual local area network ports based on the virtual local area network identifier; and activating the target virtual local area network port.

In some embodiments of the present application, the management compact switching processing unit is connected to the physical port; the configuration data includes a target state and executing data corresponding to the target state; and the generating the configuration information based on the configuration data includes:
merging the target state and the executing data corresponding to the target state to generate the configuration information, wherein the baseboard management controller is configured to detect a port state of the physical port; and in response to the port state matching the target state, configuring the management compact switching processing unit to process the executing data.

In some embodiments of the present application, the method further includes:
in response to a response signal fed back by the baseboard management controller for the heartbeat trigger signal being not received within a preset aging time, determining that the baseboard management controller is in a reboot state; and
in response to the baseboard management controller being in the reboot state, transmitting the configuration information to the baseboard management controller.

In some embodiments of the present application, the method further includes:
in response to receiving the response signal within the preset aging time, updating the preset aging time.

Third, the method for processing the baseboard management controller port is applied to the white-box switch. The white-box switch includes a baseboard management controller and a processor, the baseboard management controller and the processor are both connected to a management compact switching processing unit, and the management compact switching processing unit is connected to a physical port; and the method includes:
in response to a boot instruction, acquiring, by the baseboard management controller, an initial configuration file;
configuring, by the baseboard management controller, the initial configuration file and executing a default mode;
receiving, by the processor, input configuration data;
generating, by the processor, configuration information based on the configuration data;
based on a preset heartbeat timing, transmitting, by the processor, a heartbeat trigger signal to the baseboard management controller via a management port, wherein the heartbeat trigger signal carries the configuration information; and
configuring, by the baseboard management controller in the default mode, the management compact switching processing unit based on the configuration information.

In some embodiments of the present application, the generating, by the processor, the configuration information based on the configuration data includes:
transforming a virtual local area network identifier to generate the configuration information; and
the configuring, by the baseboard management controller in the default mode, the management compact switching processing unit based on the configuration information includes:
determining a target virtual local area network port from a plurality of virtual local area network ports based on the virtual local area network identifier; and activating the target virtual local area network port.

In some embodiments of the present application, the management compact switching processing unit is connected to the physical port; the configuration data includes a target state and executing data corresponding to the target state; the generating, by the processor, the configuration information based on the configuration data includes:
merging the target state and the executing data corresponding to the target state to generate the configuration information; and
the configuring, by the baseboard management controller in the default mode, the management compact switching processing unit based on the configuration information includes:
detecting a port state of the physical port, and in response to the port state matching the target state, configuring the management compact switching processing unit to process the executing data.

In some embodiments of the present application, the method further includes:
in response to a response signal fed back by the baseboard management controller for the heartbeat trigger signal being not received within a preset aging time, determining, by the processor, that the baseboard management controller is in a reboot state;
in response to the baseboard management controller being in the reboot state, transmitting, by the processor, the configuration information to the baseboard management controller; and
in response to receiving the response signal within the preset aging time, updating, by the processor, the preset aging time.

In some embodiments of the present application, the method further includes:
in response to the heartbeat trigger signal being not received within the preset aging time, determining, by the baseboard management controller, that the processor is in the reboot state;
in response to the processor being in the reboot state, configuring, by the baseboard management controller, the initial configuration file; and
in response to receiving the heartbeat trigger signal within the preset aging time, feeding back, by the baseboard management controller, a response signal to the processor and updating the preset aging time.

In the present specification, various embodiments are described in a progressive manner, each of which focuses on a departure from the other embodiments, and reference should be made to the same or similar parts throughout the various embodiments.

A person skilled in the art should understand that the embodiments of the present application may provide a method, an apparatus, or a computer program product. Therefore, the present application may use the form of complete hardware embodiments, complete software embodiments, or software and hardware combination embodiments. In addition, embodiments of the present application may use the form of a computer program product implemented on one or more computer-readable storage media (including, but not limited to, a magnetic disk memory, a compact disc read-only memory (CD-ROM), an optical memory, etc.) including computer-readable program codes.

The embodiments of the present application are described by referring to the flowcharts or block diagrams of methods, terminal devices (systems), and computer program products according to the embodiments of the present application. It should be understood that computer program instructions may implement each flow and/or each block in the flowcharts and/or the block diagrams, and combination of the flows and/or the blocks in the flowcharts and/or the block diagrams. These computer program instructions may be provided for a general computer, a dedicated computer, an embedded processor or processors of other programmable data processing terminal devices to generate a machine, thereby making the instructions that are executed by the computer or the processors of other programmable data processing terminal devices generate apparatuses for achieving specified functions in one or more flows of the flowcharts and/or one or more blocks of the block diagrams.

These computer program instructions also may be stored in a computer-readable memory capable of guiding the computer or other programmable data processing terminal devices to work in a particular manner, thereby making the instructions that are stored in the computer-readable memory generate manufactured products that include instruction apparatuses. The instruction apparatuses achieve the specified functions in one or more flows of the flowcharts and/or one or more blocks of the block diagrams.

These computer program instructions also may be loaded onto the computer or other programmable data processing terminal devices to execute a series of operation steps on the computer or other programmable data processing terminal devices to generate computer implemented processing, so that the instructions executed on the computer or other programmable data processing terminal devices provide steps for achieving the specified functions in one or more flows of the flowcharts and/or one or more blocks of the block diagrams.

Although the embodiments of the present application have been described, those skilled in the art, upon learning the fundamental inventive concept, may make additional changes and modifications to these embodiments. Accordingly, the appended claims are intended to be construed as encompassing the embodiments as well as all changes and modifications that fall within the scope of the present application.

Finally, it is noted that relational terms such as first and second, and the like, may be used solely to distinguish one entity or action from another entity or action without necessarily requiring or implying any actual such relationship or order between such entities or actions. Furthermore, the terms “include”, “including”, or any other variation thereof, are intended to cover a non-exclusive inclusion, such that a process, method, article, or terminal device that includes a list of elements does not include only those elements but may include other elements not expressly listed or inherent to such process, method, article, or terminal device. An element proceeded by “includes a . . . ” does not, without more constraints, preclude the existence of additional identical elements in the process, method, article, or terminal device that includes the element.

The method for processing the baseboard management controller port and the application device thereof provided by the present application are introduced above in detail, the principle and implementations of the present application are elaborated with examples in the present application, and the descriptions made to the embodiments are only adopted to help the method of the present application and the core concept thereof to be understood. In addition, those of ordinary skill in the art may make variations to the implementations and the application scope according to the concept of the present application. From the above, the contents of the specification should not be understood as limits to the present application.

1. A method for processing a baseboard management controller port, applied to a baseboard management controller, wherein the baseboard management controller and a processor are both connected to a management compact switching processing unit, and a management port is disposed between the baseboard management controller and the processor; and the method comprises:
in response to a boot instruction, acquiring an initial configuration file;
configuring the initial configuration file and executing a default mode;
in the default mode, receiving a heartbeat trigger signal of the processor via the management port, wherein the heartbeat trigger signal carries configuration information; and
configuring the management compact switching processing unit based on the configuration information.

2. The method according to claim 1, wherein the management compact switching processing unit has a plurality of virtual local area network ports; the configuration information comprises a virtual local area network identifier; and the configuring the management compact switching processing unit based on the configuration information comprises:
determining a target virtual local area network port from the plurality of virtual local area network ports based on the virtual local area network identifier; and
activating the target virtual local area network port.

3. The method according to claim 1, wherein the management compact switching processing unit is connected to a physical port; the configuration information comprises a target state and executing data corresponding to the target state; and the configuring the management compact switching processing unit based on the configuration information comprises:
detecting a port state of the physical port; and
in response to the port state matching the target state, configuring the management compact switching processing unit to process the executing data.

4. The method according to claim 1, wherein the method further comprises:
in response to the heartbeat trigger signal being not received within a preset aging time, determining that the processor is in a reboot state; and
in response to the processor being in the reboot state, configuring the initial configuration file.

5. The method according to claim 4, wherein the method further comprises:
in response to receiving the heartbeat trigger signal within the preset aging time, feeding back a response signal to the processor and updating the preset aging time.

6. A method for processing a baseboard management controller port, applied to a processor, wherein the processor and a baseboard management controller are both connected to a management compact switching processing unit, the management compact switching processing unit is connected to a physical port, a management port is disposed between the baseboard management controller and the processor; the baseboard management controller is configured to, in response to a boot instruction, acquire an initial configuration file, configure the initial configuration file, and execute a default mode; and the method comprises:
receiving input configuration data;
generating configuration information based on the configuration data; and
based on a preset heartbeat timing, transmitting a heartbeat trigger signal to the baseboard management controller via the management port, wherein the heartbeat trigger signal carries the configuration information, and the baseboard management controller is further configured to receive the configuration information and configure the management compact switching processing unit based on the configuration information.

7. The method according to claim 6, wherein the configuration data comprises a virtual local area network identifier; and the generating the configuration information based on the configuration data comprises:
transforming the virtual local area network identifier to generate the configuration information, wherein the baseboard management controller is configured to determine a target virtual local area network port from a plurality of virtual local area network ports based on the virtual local area network identifier; and
activating the target virtual local area network port.

8. The method according to claim 6, wherein the configuration data comprises a target state and executing data corresponding to the target state; and the generating the configuration information based on the configuration data comprises:
merging the target state and the executing data corresponding to the target state to generate the configuration information, wherein the baseboard management controller is configured to detect a port state of the physical port; and in response to the port state matching the target state, configuring the management compact switching processing unit to process the executing data.

9. The method according to claim 6, wherein the method further comprises:
in response to a response signal fed back by the baseboard management controller for the heartbeat trigger signal being not received within a preset aging time, determining that the baseboard management controller is in a reboot state; and
in response to the baseboard management controller being in the reboot state, transmitting the configuration information to the baseboard management controller.

10. The method according to claim 9, wherein the method further comprises:
in response to receiving the response signal within the preset aging time, updating the preset aging time.

11. A method for processing a baseboard management controller port, applied to a white-box switch, wherein the white-box switch comprises a baseboard management controller and a processor, the baseboard management controller and the processor are both connected to a management compact switching processing unit, and the management compact switching processing unit is connected to a physical port; a management port is disposed between the baseboard management controller and the processor; and the method comprises:
in response to a boot instruction, acquiring, by the baseboard management controller, an initial configuration file;
configuring, by the baseboard management controller, the initial configuration file and executing a default mode;
receiving, by the processor, input configuration data;
generating, by the processor, configuration information based on the configuration data;
based on a preset heartbeat timing, transmitting, by the processor, a heartbeat trigger signal to the baseboard management controller via the management port, wherein the heartbeat trigger signal carries the configuration information; and
configuring, by the baseboard management controller in the default mode, the management compact switching processing unit based on the configuration information.

12. The method according to claim 11, wherein the generating, by the processor, the configuration information based on the configuration data comprises:
transforming a virtual local area network identifier to generate the configuration information; and
the configuring, by the baseboard management controller in the default mode, the management compact switching processing unit based on the configuration information comprises:
determining a target virtual local area network port from a plurality of virtual local area network ports based on the virtual local area network identifier; and activating the target virtual local area network port.

13. The method according to claim 11, wherein the configuration data comprises a target state and executing data corresponding to the target state; the generating, by the processor, the configuration information based on the configuration data comprises:
merging the target state and the executing data corresponding to the target state to generate the configuration information; and
the configuring, by the baseboard management controller in the default mode, the management compact switching processing unit based on the configuration information comprises:
detecting a port state of the physical port, and in response to the port state matching the target state, configuring the management compact switching processing unit to process the executing data.

14. The method according to claim 11, wherein the method further comprises:
in response to a response signal fed back by the baseboard management controller for the heartbeat trigger signal being not received within a preset aging time, determining, by the processor, that the baseboard management controller is in a reboot state;
in response to the baseboard management controller being in the reboot state, transmitting, by the processor, the configuration information to the baseboard management controller; and
in response to receiving the response signal within the preset aging time, updating, by the processor, the preset aging time.

15. The method according to claim 11, wherein the method further comprises:
in response to the heartbeat trigger signal being not received within a preset aging time, determining, by the baseboard management controller, that the processor is in a reboot state;
in response to the processor being in the reboot state, configuring, by the baseboard management controller, the initial configuration file; and
in response to receiving the heartbeat trigger signal within the preset aging time, feeding back, by the baseboard management controller, a response signal to the processor and updating the preset aging time.

16. A baseboard management controller, wherein the baseboard management controller and a processor are both connected to a management compact switching processing unit, and a management port is disposed between the baseboard management controller and the processor; and the baseboard management controller is configured to implement the steps of the method for processing the baseboard management controller port according to claim 1.

17. A processor, wherein the processor and a baseboard management controller are both connected to a management compact switching processing unit, and the management compact switching processing unit is connected to a physical port; a management port is disposed between the baseboard management controller and the processor; the baseboard management controller is configured to, in response to a boot instruction, acquire an initial configuration file, configure the initial configuration file, and execute a default mode; and the processor is configured to implement the steps of the method for processing the baseboard management controller port according to claim 6.

18. A white-box switch, comprising a baseboard management controller and a processor, wherein the baseboard management controller and the processor are both connected to a management compact switching processing unit, the management compact switching processing unit is connected to a physical port, and a management port is disposed between the baseboard management controller and the processor; and the white-box switch is configured to implement the steps of the method for processing the baseboard management controller port according to claim 11.

19. An electronic device, comprising a processor, a memory, and a computer program stored on the memory and capable of running on the processor, wherein the computer program, in response to being executed by the processor, implements the steps of the method for processing the baseboard management controller port according to claim 1.

20. A non-transitory readable storage medium, storing a computer program therein, wherein the computer program, in response to being executed by a processor, implements the steps of the method for processing the baseboard management controller port according to claim 1.
